(19) United States
(12) Patent Application Publication
(10) Pub. No.: US 2002/0149838 A1
(43) Pub. Date: Oct. 17, 2002

(54) Optical amplification system or group employing multiple pump laser groupings

(76) Inventors: Quan-Zhen Wang, New York, NY (US); William Shieh, Columbia, MD (US); Vladimir Petricevic, Columbia, MD (US)

Correspondence Address: Johnny A. Kumar, FOLEY & LARDNER, Suite 500, 3000 K Street, N.W., Washington, DC, 20007-5109, US

(21) Appl. No.: 09/832,175

(22) Filed: Apr. 11, 2001

(51) Int. Cl. H01S 3/00

(52) U.S. Cl. 359/334; 359/341.33

(57) ABSTRACT

An optical amplification system is described. The system includes a series of optical amplifier groups optically connected in series. Each optical amplifier group comprising multiple optical amplifiers. The optical amplifiers of a particular amplifier group each produces pump radiation having a different set of pump wavelengths and pump powers corresponding to the respective pump wavelengths. Each amplifier group provides a desired gain profile, such as a substantially flat gain profile, over a first range of optical signal wavelengths.

### FIELD OF THE INVENTION

This invention generally relates to optical communication systems and specifically to optical communication systems using Raman amplifiers.

### BACKGROUND OF THE INVENTION

Wave division multiplexing (WDM) increases bandwidth in optical communications by providing for communication over several wavelengths or channels. For long haul optical communications the optical signal must be periodically amplified. To maximize WDM capacity, it is desirable that the optical bandwidth of the system be as wide as possible. Raman amplification is one of the amplification schemes that can provide a broad and relatively flat gain profile over the wavelength range used in WDM optical communications. (See Y. Emori, “100 nm bandwidth flat-gain Raman Amplifiers pumped and gain-equalized by 12-wavelength channel WDM Diode Unit,” Electronic Lett., Vol. 35, no 16, p. 1355 (1999) and F. Koch et. al., “Broadband gain flattended Raman Amplifiers to extend to the third telecommunication window,” OFC'2000, Paper FF3, (2000)). Raman amplifiers may be either distributed or discrete (See High Sensitivity 1.3 μm Optically Pre-Amplified Receiver Using Raman Amplification,” Electronic Letters, vol. 32, no. 23, p. 2164 (1996)). The Raman gain material in distributed Raman amplifiers is the transmission optical fiber, while a special spooled gain fiber is typically used in discrete Raman amplifiers.

Raman amplifiers use stimulated Raman scattering to amplify a signal at a signal wavelength. In stimulated Raman scattering, radiation power from a pump radiation source is transferred to an optical signal to increase the power of the optical signal. The frequency (and therefore photon energy) of the radiation emitted by the pump radiation source is greater than the frequency of the radiation of the optical signal. This down shift in frequency from the pump frequency to the signal radiation frequency is due to the pump light interaction with optical phonons (vibrations) of the Raman gain material, i.e., the medium through which the pump radiation and the optical signal are traversing.

The Raman gain material in Raman amplifiers can be the transmission optical fiber itself. The Raman gain coefficient for a silica glass fiber (such as are typically used in optical communications) is shown in FIG. 1 as a function of the wavelength shift relative to a pump wavelength of around about 1400 nm. As can be seen, the largest gain occurs at about a 100 nm shift. Thus, the maximum gain for a single pump wavelength of about 1400 nm will occur at a signal wavelength of about 1500 nm. Since the optical gain is proportional to the pump intensity, the gain of the signal of a Raman amplifier is the product of the Raman gain coefficient and the pump intensity.

The gain profile having a typical bandwidth of 20-30 nm for a single pump wavelength is too narrow for WDM optical communications applications where a broad range of wavelengths must be amplified. To broaden the gain profile, Raman amplifiers employing multiple pump wavelengths over a broad wavelength range have been suggested for use in WDM optical communication applications. For example, it has been suggested to use twelve pump wavelengths to achieve a 100 nm bandwidth Raman amplifier.

In order for a flat gain profile to be achieved, the pump-pump interactions generally require that the shorter pump wavelengths have a higher pump power than the longer pump wavelengths. This is so because energy from the shorter wavelength (higher photon energy) pumps is transferred to the longer wavelength pumps due to stimulated Raman scattering. To compensate for the pump-pump energy loss at shorter wavelengths, the shorter pump wavelengths should have increased power.

A typical pump power-pump wavelength scheme to achieve a relatively flat and broad Raman gain profile is illustrated in FIG. 2 for the case of twelve pump wavelengths. As can be seen in FIG. 2, the pump power decreases for increasing wavelength. Also, the spacing between wavelengths is closer for shorter wavelengths. FIG. 3 illustrates a relatively flat and broad Raman gain profile for a pump power-pump wavelength scheme similar to that of FIG. 2. The variations on the gain spectrum result in channel-to-channel variation in the optical-signal-to-noise-ratio (OSNR) and absolute signal power. Because system performance is limited by the OSNR of the worst performing wavelength, a large variation can severely limit system length. The maximum difference of the gain within the spectral range of signals is called gain ripple. The gain ripple of an amplifier should be as small as possible. This can be achieved by properly selecting the pump wavelengths and powers of the Raman amplifier. As can be seen in FIG. 3, the gain ripple over the wavelength range of 1520 to 1620 nm is smaller than 1.5 dB.

FIG. 4 is a schematic of a typical optical communication system using Raman amplifiers for periodic amplification of the optical signal. The system includes transmitter terminal 10 and receiver terminal 12. The transmitter terminal includes a number of optical communication transmitters 14a, 14b, . . . 14z respectively transmitting signals at optical communications wavelengths λa, λb, . . . λz.

The optical signals are multiplexed by multiplexer 16 and are amplified by a series of amplifiers A1, A2, . . . An. The signals are transmitted from the transmitter 10 to the amplifiers, between the amplifiers, and from the amplifiers to the receiver 12 via transmission optical fiber 26. For distributed Raman amplification, the optical amplifier will also include transmission optical fiber. The optical signals are then demultiplexed by demultiplexer 18 of receiver 12 to respective optical communications receivers 20a, 20b, . . . 20z. The demultiplexer 18 sends optical communications wavelengths λa, λb, . . . λz to respective optical communications receivers 20a, 20b, . . . 20z.

Although FIG. 4 shows signals directed from transmitter terminal 10 to receiver terminal 12 for ease of illustration, in general the transmitter terminal 10 and receiver terminal 12 are typically transmitter/receiver terminals for bidirectional communication. In this case each of the transmitter/receiver terminals will have transmitters as well as receivers and both a multiplexer and demultiplexer.

Each amplifier of the series of amplifiers A1, A2, . . . An is designed to be of the same type, i.e., each amplifier is designed to provide the same set of pump wavelengths with the same pump power. For example, each amplifier is designed to provide the pump power pump wavelength scheme illustrated in FIG. 2. In this scheme, for example twelve pump lasers are employed in each amplifier.

### SUMMARY OF THE INVENTION

According to one embodiment of the present invention there is provided an optical amplification system comprising: a series of optical amplifier groups optically connected in series, each optical amplifier group comprising multiple optical amplifiers, the optical amplifiers of a particular amplifier group each producing pump radiation having a different set of pump wavelengths and pump powers corresponding to the respective pump wavelengths, such that each amplifier group provides a substantially flat gain profile over a first range of optical signal wavelengths.

According to another embodiment of the present invention there is provided an optical amplifier group comprising: multiple optical amplifiers, the optical amplifiers connected in series, each optical amplifier of the multiple optical amplifiers producing pump radiation having a different set of pump wavelengths and pump powers corresponding to the respective pump wavelengths, such that the amplifier group provides a substantially flat gain profile over a first range of optical signal wavelengths.

According to another embodiment of the present invention there is provided a method of amplifying optical signals comprising: optically coupling an optical signal having a signal wavelength with a first pump wavelength spectrum to provide a first amplification of the signal, the first pump wavelength spectrum having a first set of pump wavelengths and pump powers respectively corresponding to the pump wavelengths; optically coupling the signal, after the first amplification, with at least one second pump wavelength spectrum to provide at least one second amplification of the signal, the at least one second pump wavelength spectrum having at least one second set of pump wavelengths and pump powers respectively corresponding to the pump wavelengths, the at least one second set of pump wavelengths and pump powers being different from the first set of pump wavelengths and pump powers, wherein the combination of the first amplification and the second amplification provides a substantially flat gain profile over a first range of signal wavelengths.

### BRIEF DESCRIPTION OF THE DRAWINGS

FIG. 1 is a graph showing the Raman gain coefficient as a function of wavelength shift from a pump wavelength for a silica glass fiber.

FIG. 2 shows a typical pump power-pump wavelength scheme according to a prior art system.

FIG. 3 illustrates the Raman gain profile for a pump power-pump wavelength scheme similar to that of FIG. 2.

FIG. 4 is a schematic of a prior art optical communication system using Raman amplifiers for periodic amplification of the optical signal.

FIG. 5 is a schematic of an optical amplification system according to one embodiment of the invention.

FIG. 6 is a schematic of an optical amplification system according to another embodiment of the invention.

FIGS. 7A and 7B respectively illustrate a pump power-pump wavelength scheme of the amplifiers of an amplifier group having two amplifiers according to an embodiment of the invention.

FIGS. 8A and 8B illustrate the Raman gain profile for the pump power-pump wavelength scheme of FIGS. 7A and 7B.

FIG. 8C illustrates the combined Raman gain profile of the Raman gain profiles of FIGS. 8A and 8B.

FIG. 9 is a schematic of an optical amplification system according to another embodiment of the invention.

FIG. 10 is a schematic of an optical amplification system according to another embodiment of the invention.

FIG. 11 is a schematic of an amplifier, according to a preferred embodiment of the invention which may be included in the system of the present invention.

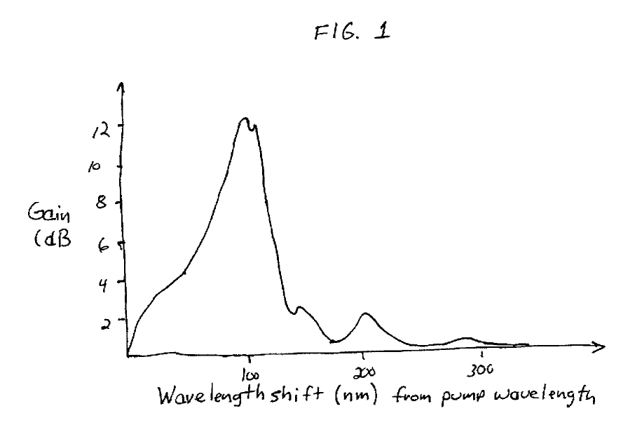

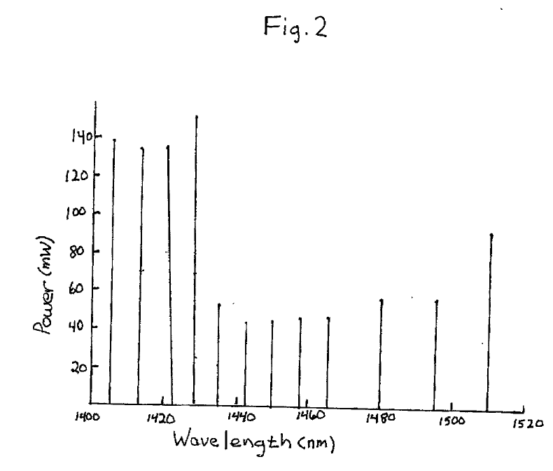

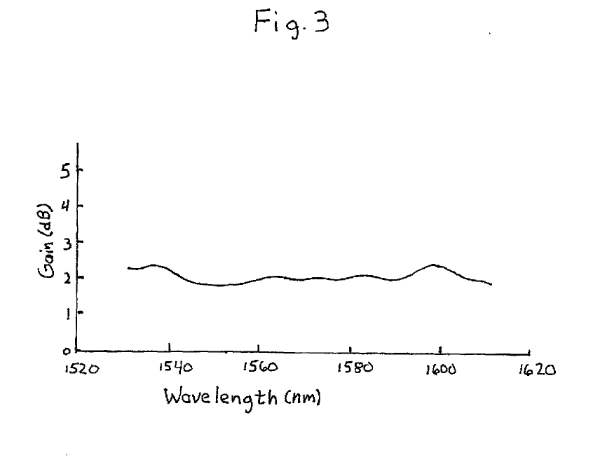

### DETAILED DESCRIPTION OF THE PREFERRED EMBODIMENTS

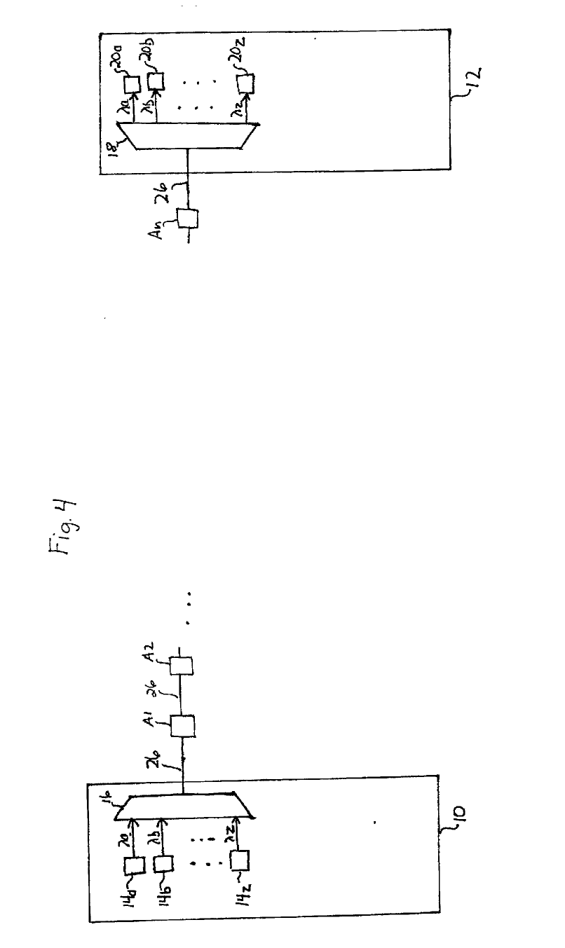

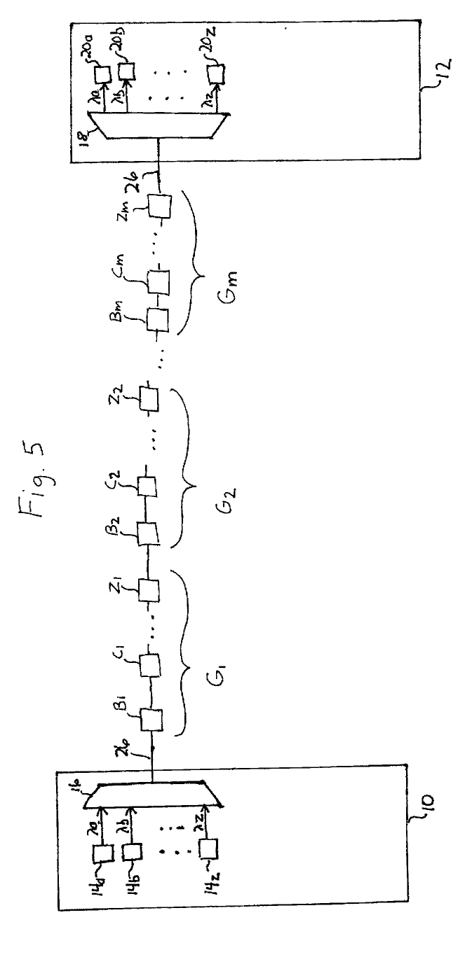

FIG. 5 is a schematic of an optical amplification system according to an embodiment of the invention. The amplifiers of the system of FIG. 5 are separated into groups of amplifiers, where each of the amplifiers in a particular group is designed to have a different set of pump wavelengths and/or pump powers corresponding to the pump wavelengths. In this application, one set of wavelengths is said to be different from another set of wavelengths if the sets of wavelengths are not identical. For example, a first set of four wavelengths λ₁₁ through λ₁₄ is different from a second set of four wavelengths, λ₂₁ through λ₂₄, if λ₁₁ through λ₁₃ are identical to λ₂₁ through λ₂₃, respectively, but λ₁₄ is different from λ₂₄. Thus, unlike the amplifiers of the system of FIG. 4, the amplifiers of the system of FIG. 5 are not designed to be of the same type.

Although only one wavelength of the different sets of wavelengths of the amplifiers in a group need be different, of course, all of the wavelengths of the sets within a group may be different, i.e, the sets of wavelengths may be entirely different. In general, the radiation corresponding to each wavelength λ will not be only the wavelength λ, but a range of wavelengths with λ as the peak wavelength. This is so because a radiation source providing the wavelength λ will not provide an infinitely narrow range of wavelengths. Thus, it is understood that radiation generated at a wavelength λ will include a finite band of wavelengths around λ.

As shown in FIG. 5, the system includes a transmitter terminal 10 and receiver terminal 12. The transmitter terminal 10 includes a number of optical communication transmitters 14a, 14b, . . . 14z respectively transmitting signals at optical communications wavelengths λa, λb, . . . λz.

The optical signals are multiplexed by multiplexer 16 and are amplified by a series of amplifiers B1, C1, . . . Z1, B2, C2, . . . , Z2, . . . , Bm, Cm, . . . Zm. The multiplexer may be a wave division multiplexer (WDM), for example. The optical signals are then demultiplexed by demultiplexer 18 of receiver 12 to respective optical communications receivers 20a, 20b, . . . 20z. The demultiplexer 18 sends optical communications wavelengths λa, λb, . . . λz to respective optical communications receivers 20a, 20b, . . . 20z.

Although FIG. 5 shows signals directed from transmitter terminal 10 to receiver terminal 12 for ease of illustration, in general the transmitter terminal 10 and receiver terminal 12 are typically transmitter/receiver terminals for bidirectional communication. In this case each of the transmitter/receiver terminals will have transmitters as well as receivers and both a multiplexer and demultiplexer.

The optical amplification system of FIG. 5 is similar to that of FIG. 4, except that Raman amplifiers B1, C1, . . . Z1, B2, C2, . . . , Z2, Bm, Cm, . . . Zm are substituted for amplifiers A1, A2, . . . An. In a similar fashion to the optical amplification system of FIG. 4, in the system of FIG. 5, the optical signals are transmitted from the transmitter 10 to the amplifiers, between the amplifiers, and from the amplifiers to the receiver 12 via transmission optical fiber 26. For distributed Raman amplification, the optical amplifier will also include transmission optical fiber.

The amplifiers of the system of FIG. 5 are separated into a number of amplifier groups, Gi, where i ranges from 1 through m. Group Gi comprises amplifiers Bi through Zi. For example, the first group, G1, comprises amplifiers B1 through Z1. While FIG. 5 illustrates that each amplifier group, Gi, comprises amplifiers B1 through Z1, the number of amplifiers in a group may be two, three or greater than three. Thus, in general, the last amplifier Zi of a group Gi may be the second, third, or nth amplifier. Some or all of the amplifier groups, Gi, may be identical. For example, G1 may be identical to G2. G1 is identical to G2 if the individual amplifiers B1 through Z1 are identical to the individual amplifiers B2 through Z2, respectively. An amplifier is identical to another amplifier if the amplifiers provide an identical set of pump wavelengths and pump powers.

FIG. 5 shows an example where each amplifier group, Gi, has the same number of amplifiers. However, the number of amplifiers in each group need not be the same.

The number of amplifier groups will depend on the total transmission length of the system. Shorter systems may require only a single amplifier group, while longer systems may require several amplifier groups.

The gain profile of a particular amplifier group will have contributions from all of the amplifiers in that group, i.e., the gain profile of a particular group will be a combination, although not necessarily a linear combination, of the individual gain profiles of the individual amplifiers of a group.

For many applications, such as applications involving wave division multiplexing (WDM) over a desired broad range of wavelengths, it will be desired to have a substantially flat gain profile, for example, with a gain ripple less than 0.5 dB, over the broad range of wavelengths. However, the present invention is not limited to a group gain profile that is substantially flat, and the group gain profile can have any shape desired.

The amplifier spacing, i.e., distance between amplifiers, of the system of FIG. 5 may in general be about the same as the amplifier spacing of the system of FIG. 4. However, because the gain profile of the system in FIG. 5 is set by the amplifier group as a whole instead of a single amplifier, the number of pump wavelengths for any particular amplifier in a group may be reduced compared with the amplifiers of the FIG. 4 system, while still maintaining a flat gain profile over a desired wavelength range. For example, if twelve pump wavelengths are required to provide a flat gain profile, the twelve pump wavelengths may be divided between the amplifiers of a group. Thus, an advantage of the present invention is a reduction in the number of pump wavelengths, or pump sources such as lasers, per amplifier. Of course more pump wavelengths than twelve may be provided. For example, eigthteen, twenty, or twenty-four wavelengths may be provided.

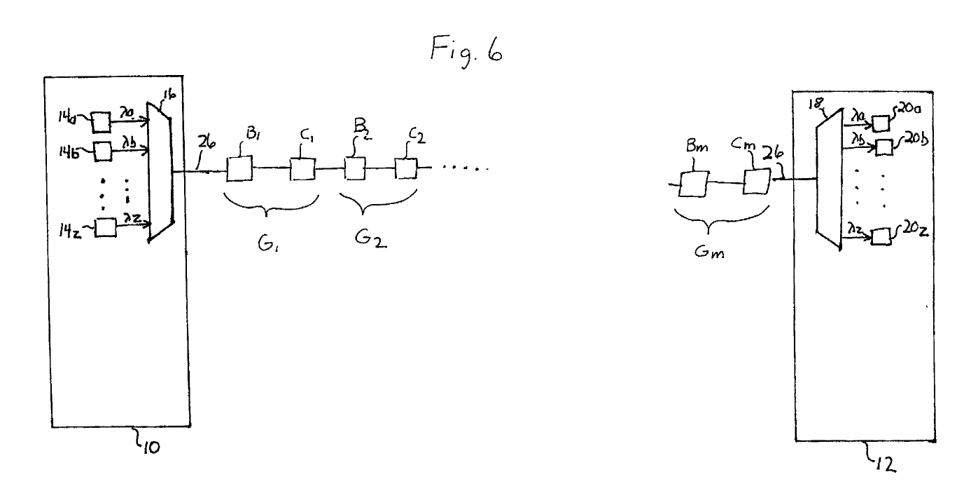

The reduction in the number of pump wavelengths required will now be explained for an amplification system schematically illustrated in FIG. 6 where it is desired to have a substantially flat gain profile over a desired first range of wavelengths. The desired first range of wavelengths may have a range width of 30 to 120 nm, for example. FIG. 6 illustrates a system with two amplifiers per amplifier group. The embodiment of FIG. 6 is similar to that of FIG. 5, except for the specific number of amplifiers per amplifier group. Thus, the description of like features designated by the same reference numerals will be omitted for the sake of brevity. Each amplifier group Gi comprises two amplifiers Bi and Ci. In the case of the prior art system of FIG. 4, twelve pump wavelengths or sources per amplifier were required to obtain a substantially flat and broad gain profile. However, because two amplifiers, Bi and Ci, in combination provide the desired gain profile, each of the amplifiers Bi and Ci may have less than twelve pump wavelengths and still provide a substantially flat gain profile. For example, each of the amplifiers Bi and Ci may individually have only six or eight pump wavelengths, but together may provide twelve to sixteen different pump wavelengths or sources.

The amplifiers Bi and Ci are preferably arranged alternately in this Raman amplification system and the amplifiers Bi and Ci preferably provide a complementary Raman gain profile. If the amplifiers Bi and Ci are arranged alternately, then all of the amplifiers Bi are identical, and all of the amplifiers Ci are identical. An amplifier is identical to another amplifier if the amplifiers provide an identical set of pump wavelengths and pump powers. By arranging Bi and Ci alternately, the signal wavelengths that are provided with a lower amplification by amplifier Bi will be provided with a higher amplification in the next amplifier Ci, and vice versa.

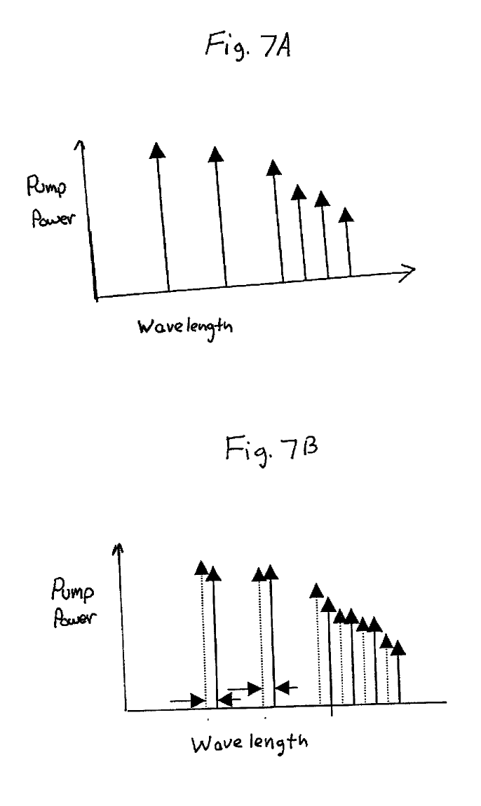

An example pump wavelength-pump power scheme for the amplifiers Bi and Ci is shown in FIGS. 7A and 7B, respectively. The pump wavelength-pump power scheme for both of the amplifiers Bi and Ci includes six wavelengths each.

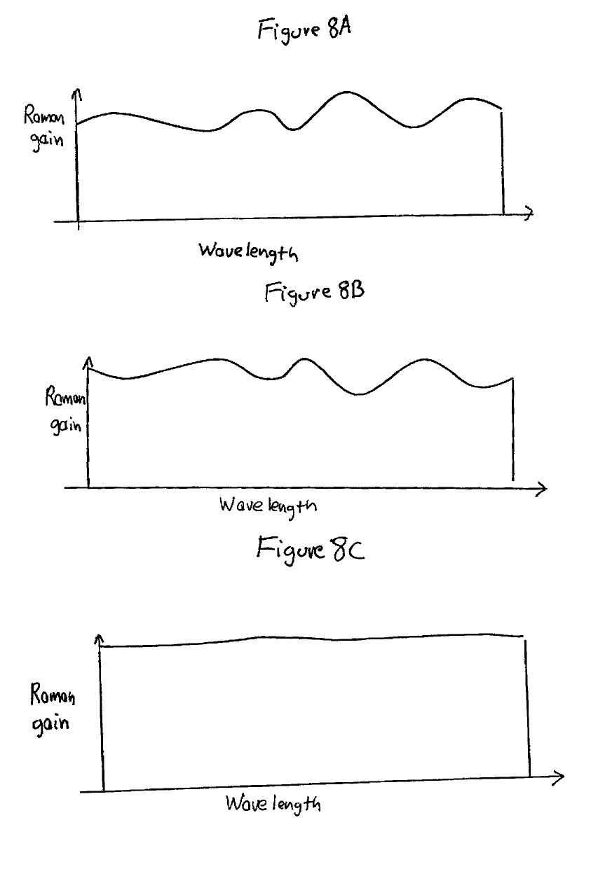

FIGS. 8A and 8B show the gain profile for the individual pump wavelength-pump power schemes of FIGS. 7A and 7B, respectively. As can be seen, the individual pump wavelength-pump power scheme for each of the Bi and Ci amplifiers does not produce a substantially flat gain profile over a broad wavelength range. However, the individual gain profiles of FIGS. 8A and 8B are complementary, i.e., the combination of the individual gain profiles produces a substantially flat gain profile.

FIG. 8C shows the combination of the individual gain profiles of FIGS. 8A and 8B. The combination gain profile in FIG. 8C is a substantially flat gain profile.

In general, once a pump wavelength scheme is chosen for the individual amplifiers of an amplifier group, the pump powers of the pump wavelengths can be set. The pump wavelengths are set so that the combined gain profile of the individual amplifiers is the desired gain profile, such as a substantially flat gain profile.

The number of pump wavelengths for each of the amplifiers Bi and Ci need not be the same. For example, one of the amplifiers Bi and Ci may have five pump wavelengths, while the other of the amplifiers Bi and Ci may have seven pump wavelengths. Further, the total number of pump wavelengths in the amplifiers Bi and Ci need not add up to twelve in order to produce a substantially flat gain profile. For example, one of the amplifiers Bi and Ci may have seven wavelengths and the other of the amplifiers may have six wavelengths. Increasing the number of pump wavelengths has the advantage of increasing the flatness of the gain profile for a given wavelength range.

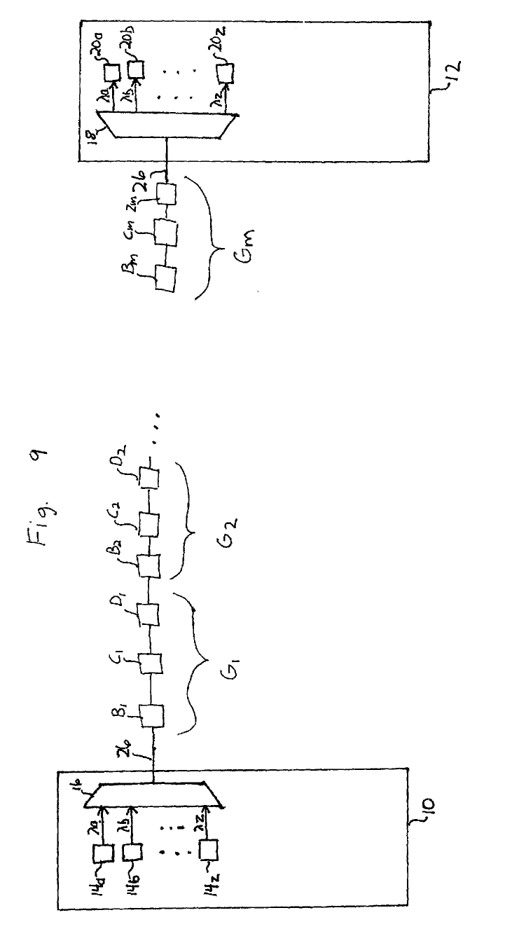

FIG. 9 shows another embodiment of the invention with three amplifiers, Bi, Ci, and Di, per amplifier group Gi. The embodiment of FIG. 9 is similar to that of FIG. 5, except for the specific number of amplifiers per amplifier group. Thus, the description of like features designated by the same reference numerals will be omitted for the sake of brevity. In the case where a substantially flat gain profile over a desired wavelength range is desired, the number of pump wavelengths per amplifier of an amplifier group may be reduced still further as compared to the system of FIG. 6. For example, the number of pump wavelengths per amplifier may be only four, or at least the number of pump wavelengths may be reduced to four for one of the amplifiers Bi, Ci, and Di, in the group Gi. However, each amplifier may have four wavelengths.

The amplifiers Bi, Ci, and Di are preferably arranged alternately in this Raman amplification system. If the amplifiers Bi, Ci, and Di are arranged alternately, then all of the amplifiers Bi are identical, all of the amplifiers Ci are identical, and all of the amplifiers Di are identical. An amplifier is identical to another amplifier if the amplifiers provide an identical set of pump wavelengths and pump powers. By arranging the amplifiers alternately, the signal wavelengths that are provided with a lower amplification by amplifier Bi will be provided with a higher amplification in the combination of the next two amplifiers Ci and Di. Likewise, the signal wavelengths that are provided with a lower amplification by amplifier Ci will be provided with a higher amplification in the combination of the next two amplifiers Di and Bi.

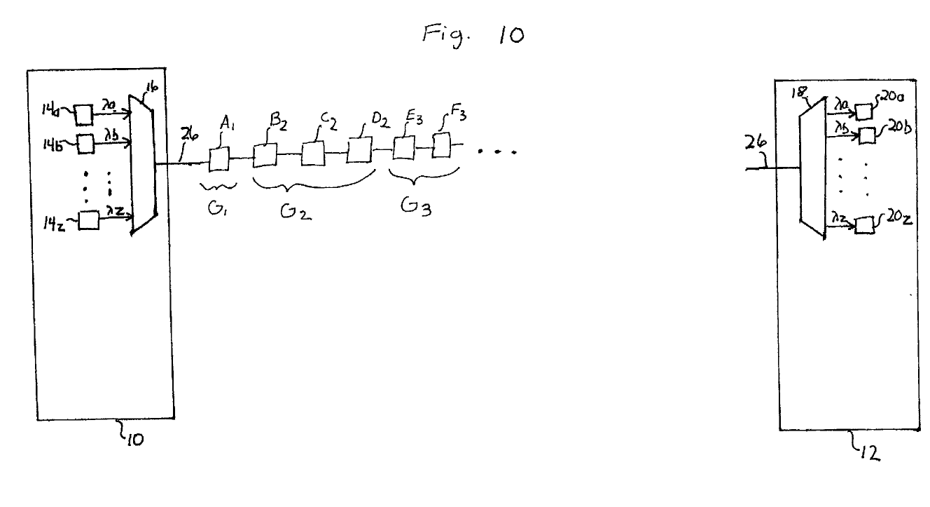

FIG. 10 shows another embodiment of the invention where the number of amplifiers per amplifier group Gi changes. The embodiment of FIG. 10 is similar to that of FIG. 5, except for the specific number of amplifiers per amplifier group. Thus, the description of like features designated by the same reference numerals will be omitted for the sake of brevity. As shown in FIG. 10, the first amplifier group G1 comprises only a single amplifier A1, the second amplifier group G2 comprises three amplifiers B2, C2, D2, and the third amplifier group G3 comprises two amplifiers E3, F3. Each of the amplifier groups Gi will provide the desired gain profile, such as, for example, a substantially flat gain profile, for a first desired range of wavelengths.

The flatness of a gain profile may be defined in terms of the gain ripple. If a flat gain profile is desired, the gain ripple of the gain profile of an amplifier group will typically be less than the gain ripple of the individual amplifiers of the amplifier group. Thus, the pump wavelength-pump power scheme of the preferred embodiments of the present invention may be such that the gain ripple of the gain profile of an amplifier group will typically be less than the gain ripple of the individual amplifiers of the amplifier group. Further the system can be designed so that the gain ripple of the overall system is less than gain ripple of the individual amplifier groups.

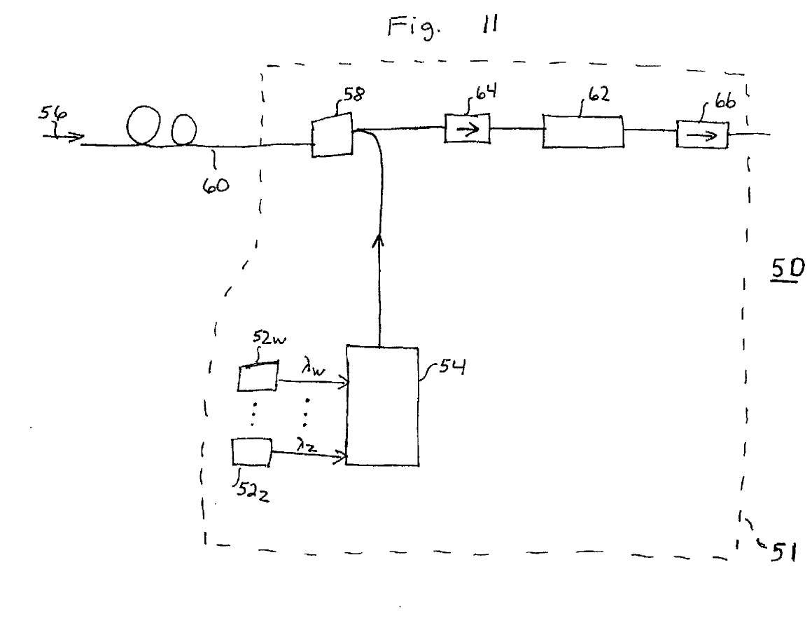

FIG. 11 is a schematic of a distributed Raman amplifier 50, according to a preferred embodiment of the invention which may be included in the system of the present invention. The amplifier 50 includes optical pump assembly 51 (shown enclosed by dashed lines) and a portion of the transmission fiber 60. Specifically FIG. 11 illustrates a Raman amplifier with four pump wavelengths. The amplifier 50 includes a number of radiation sources 52w-52z each radiation source emitting at a different one of pump wavelengths λw through λz. While the amplifier 50 schematically illustrated in FIG. 11 may have four pump wavelengths, the amplifiers employed in the present invention may have more or less than four pump wavelengths, as discussed above.

The radiation sources 52w-52z may be light emitting diodes or lasers, for example. The radiation sources may be fiber lasers, fiber coupled microchip lasers, or semiconductor lasers, for example, as is known in the art. For optical communications in the wavelength range of 1510 to 1630 nm, lasers which emit at a peak wavelength in the range of 1390 to 1510 nm would be appropriate.

The radiation sources 52w-52z emit at respective peak wavelengths λw through λz, respectively. The radiation emitted from the radiation sources 52w-52z, respectively, is coupled into a pump wavelength combiner 54, as is known in the art. The combiner may be a WDM multiplexer, for example. The pump wavelength combiner 54 combines the radiation at the pump wavelengths 52w-52z. The combined pump wavelengths are then coupled into the optical transmission fiber 60 at the pump-signal coupler 58. The optical data signal 56 is transmitted along optical fiber 60 in a direction opposite to the propagation direction of the combined pump wavelengths, i.e., the pump radiation counterpropagates relative to the optical data signal. The optical fiber 60 comprises transmission fiber, and may include, for example, lengths of single mode fiber (SMF), dispersion shifted fiber (DSF), and inverse dispersion fiber (IDF). The amplification of the signal occurs in the optical fiber 60 or in a separate amplification fiber, if desired.

The amplifier 50 may optionally include a gain flattening element 62, such as a fiber bragg grating, to further improve the flatness of the gain profile. The gain flattening element 62 is positioned between a first isolator 64 and a second isolator 66. The first and second isolators 64 and 66 act to allow electromagnetic radiation to pass only in the direction that the signal 56 propagates. After the signal 56 passes through the second isolator, the signal 56 propagates along a transmission optical fiber (not shown).

The gain profile produced by a particular amplifier group need not be substantially flat, but may be any desired gain profile. For example, in the gain profile desired the gain may be steadily increasing at a constant rate, or may have a curved shape.

The preferred embodiments have been set forth herein for the purpose of illustration. However, this description should not be deemed to be a limitation on the scope of the invention. Accordingly, various modifications, adaptations, and alternatives may occur to one skilled in the art without departing from the scope of the claimed inventive concept.

What is claimed is:

1. An optical amplification system comprising:
a series of optical amplifier groups optically connected in series, each optical amplifier group comprising multiple optical amplifiers, the optical amplifiers of a particular amplifier group each producing pump radiation having a different set of pump wavelengths and pump powers corresponding to the respective pump wavelengths, such that each amplifier group provides a substantially flat gain profile over a first range of optical signal wavelengths.

2. The amplification system of claim 1, wherein the first range of optical signal wavelengths has a range width of 20 to 120 nm.

3. The amplification system of claim 1, wherein the optical amplifiers are Raman amplifiers.

4. The amplification system of claim 1, further comprising:
an optical signal transmitter that transmits multiple optical signals to the series of optical amplifier groups, the multiple optical signals having respective different wavelengths, where the series of optical amplifiers acts to amplify the multiple optical signals; and
an optical signal receiver that receives the multiple optical signals from the series of optical amplifiers.

5. The amplification system of claim 4, wherein the optical signal transmitter includes a wave division multiplexer.

6. The amplification system of claim 1, wherein all the pump wavelengths of each set of pump wavelengths of a respective optical amplifier group are different from the pump wavelengths of remaining sets of pump wavelengths of the respective optical amplifier group.

7. The amplification system of claim 1, wherein each of the optical amplifiers further comprises radiation sources that emit radiation at respective pump wavelengths of a respective set of pump wavelengths.

8. The amplification system of claim 7, wherein the radiation sources are lasers or light emitting diodes.

9. The amplification system of claim 1, further comprising:
a transmission optical fiber between the optical amplifiers that transmits the optical signals.

10. The optical amplification system of claim 1, wherein the number of optical amplifiers in each optical amplifier group is two.

11. The optical amplification system of claim 10, wherein the gain profiles of the optical amplifiers in a respective optical amplifier group are complementary to each other.

12. The optical amplification system of claim 1, wherein the number of optical amplifiers in each optical amplifier group is three or greater.

13. The optical amplification system of claim 1, wherein the number of optical amplifiers in each amplifier group is the same, and the optical amplifiers in the system are arranged alternately.

14. An optical amplification system comprising:
a series of optical amplifier groups optically connected in series, each optical amplifier group comprising multiple optical amplifiers, the optical amplifiers of a particular amplifier group each producing pump radiation having a different set of pump wavelengths and pump powers corresponding to the respective pump wavelengths, each optical amplifier having a respective gain profile and gain ripple, such that each amplifier group provides a gain profile with a gain ripple that is less than the gain ripple of the gain profile of each individual optical amplifier of the amplifier group over a first range of optical signal wavelengths.

15. The amplification system of claim 14, wherein the gain ripple of the optical amplification system is less than the gain ripple of each individual amplifier group.

16. The amplification system of claim 14, wherein the first range of optical signal wavelengths has a range width of 20 to 120 nm.

17. The amplification system of claim 14, wherein the gain ripple is less than 0.5 dB.

18. The amplification system of claim 14, wherein optical amplifiers are Raman amplifiers.

19. The optical amplification system of claim 14, wherein the number of optical amplifiers in each optical amplifier group is two.

20. The optical amplification system of claim 19, wherein the gain profiles of the optical amplifiers in a respective optical amplifier group are complementary to each other.

21. The optical amplification system of claim 14, wherein the number of optical amplifiers in each optical amplifier group is three or greater.

22. The optical amplification system of claim 14, wherein the number of optical amplifiers in each amplifier group is the same, and the optical amplifiers in the system are arranged alternately.

23. An optical amplification system comprising:
a series of optical amplifier groups optically connected in series, each optical amplifier group comprising multiple optical amplifiers, the optical amplifiers of a particular amplifier group each producing pump radiation having a different set of pump wavelengths and pump powers corresponding to the respective pump wavelengths, such that each amplifier group provides a desired gain profile over a first range of optical signal wavelengths.

24. The amplification system of claim 23, wherein the gain profiles of the optical amplifiers in a respective optical amplifier group are complementary to each other.

25. The amplification system of claim 23, wherein the optical amplifiers are Raman amplifiers.

26. The optical amplification system of claim 23, wherein the number of optical amplifiers in each optical amplifier group is two.

27. The optical amplification system of claim 23, wherein the number of optical amplifiers in each optical amplifier group is three or greater.

28. The optical amplification system of claim 23, wherein the number of optical amplifiers in each amplifier group is the same, and the optical amplifiers in the system are arranged alternately.

29. An optical amplifier group comprising:
multiple optical amplifiers, the optical amplifiers connected in series, each optical amplifier of the multiple optical amplifiers producing pump radiation having a different set of pump wavelengths and pump powers corresponding to the respective pump wavelengths, such that the amplifier group provides a substantially flat gain profile over a first range of optical signal wavelengths.

30. The optical amplifier group of claim 29, wherein the optical amplifiers are Raman amplifiers.

31. The amplification system of claim 29, wherein the first range of optical signal wavelengths has a range width of 20 to 120 nm.

32. An optical amplifier group comprising:
multiple optical amplifiers, the optical amplifiers connected in series, each optical amplifier of the multiple optical amplifiers producing pump radiation having a different set of pump wavelengths and pump powers corresponding to the respective pump wavelengths, each optical amplifier having a respective gain profile and gain ripple, such that the amplifier group provides a gain profile with a gain ripple that is less than the gain ripple of the individual optical amplifiers of the amplifier group over a first range of optical signal wavelengths.

33. The optical amplifier group of claim 32, wherein the optical amplifiers are Raman amplifiers.

34. The amplification system of claim 32, wherein the first range of optical signal wavelengths has a range width of 20 to 120 nm.

35. An optical amplifier group comprising:
multiple optical amplifiers, the optical amplifiers connected in series, each optical amplifier of the multiple optical amplifiers producing pump radiation having a different set of pump wavelengths and pump powers corresponding to the respective pump wavelengths, such that the amplifier group provides a desired gain profile over a first range of optical signal wavelengths.

36. The optical amplifier group of claim 35, wherein the gain profiles of the optical amplifiers in a respective optical amplifier group are complementary to each other.

37. The optical amplifier group of claim 35, wherein the optical amplifiers are Raman amplifiers.

38. The amplification system of claim 35, wherein the first range of optical signal wavelengths has a range width of 20 to 120 nm.

39. A method of amplifying optical signals comprising:
optically coupling optical signals, having signal wavelengths within a first range of signal wavelengths, with a first pump wavelength spectrum to provide a first amplification of the signals, the first pump wavelength spectrum having a first set of pump wavelengths and pump powers respectively corresponding to the pump wavelengths;
optically coupling the signals, after the first amplification, with at least one second pump wavelength spectrum to provide at least one second amplification of the signals, the at least one second pump wavelength spectrum having at least one second set of pump wavelengths and pump powers respectively corresponding to the pump wavelengths, the at least one second set of pump wavelengths and pump powers being different from the first set of pump wavelengths and pump powers, wherein the combination of the first amplification and the second amplification provides a substantially flat gain profile over the first range of signal wavelengths.

40. The method of claim 39, wherein the first range of optical signal wavelengths has a range width of 20 to 120 nm.

41. A method of amplifying optical signals comprising:
optically coupling signals, having signal wavelengths within a first range of signal wavelengths, with a first pump wavelength spectrum to provide a first amplification of the signals, the first pump wavelength spectrum having a first set of pump wavelengths and pump powers respectively corresponding to the pump wavelengths;
optically coupling the signals, after the first amplification, with at least one second pump wavelength spectrum to provide at least one second amplification of the signals, the at least one second pump wavelength spectrum having at least one second set of pump wavelengths and pump powers respectively corresponding to the pump wavelengths, the at least one second set of pump wavelengths and pump powers being different from the first set of pump wavelengths and pump powers, wherein the combination of the first amplification and the second amplification provides a desired gain profile over the first range of signal wavelengths.

42. The method of claim 41, wherein the first range of optical signal wavelengths has a range width of 20 to 120 nm.

43. The method of claim 39, wherein the at least one second pump wavelength spectrum comprises a second pump wavelength spectrum and a third pump wavelength spectrum and the optically coupling the signals with at least one second pump wavelength spectrum comprises:
optically coupling the signals, after the first amplification, with the second pump wavelength spectrum to provide a second amplification of the signals, the second pump wavelength spectrum having a second set of pump wavelengths and pump powers respectively corresponding to the pump wavelengths, the second set of pump wavelengths and pump powers being different from the first set of pump wavelengths and pump powers; and
optically coupling the signals, after the first and second amplifications, with the third pump wavelength spectrum to provide a third amplification of the signals, the third pump wavelength spectrum having a third set of pump wavelengths and pump powers respectively corresponding to the pump wavelengths, the third set of pump wavelengths and pump powers being different from the first set of pump wavelengths and pump powers and the second set of pump wavelengths and pump powers, wherein the combination of the first, second and third amplification provides the substantially flat gain profile over the first range of signal wavelengths.

44. The method of claim 41, wherein the at least one second pump wavelength spectrum comprises a second pump wavelength spectrum and a third pump wavelength spectrum and the optically coupling the signals with at least one second pump wavelength spectrum comprises:
optically coupling the signals, after the first amplification, with the second pump wavelength spectrum to provide a second amplification of the signals, the second pump wavelength spectrum having a second set of pump wavelengths and pump powers respectively corresponding to the pump wavelengths, the second set of pump wavelengths and pump powers being different from the first set of pump wavelengths and pump powers; and
optically coupling the signals, after the first and second amplifications, with the third pump wavelength spectrum to provide a third amplification of the signals, the third pump wavelength spectrum having a third set of pump wavelengths and pump powers respectively corresponding to the pump wavelengths, the third set of pump wavelengths and pump powers being different from the first set of pump wavelengths and pump powers and the second set of pump wavelengths and pump powers, wherein the combination of the first, second and third amplification provides the desired gain profile over the first range of signal wavelengths.
